(19) United States
(12) Patent Application Publication
(10) Pub. No.: US 2020/0390268 A1
(43) Pub. Date: Dec. 17, 2020

(54) Pour Over Coffee Maker

(71) Applicant: CSTEK CO., LTD., Taichung City (TW)

(72) Inventor: Chuan-Che Chiang, Taichung City (TW)

(21) Appl. No.: 16/441,528

(22) Filed: Jun. 14, 2019

(51) Int. Cl. A47J 31/10; A47J 31/46

(52) U.S. Cl. CPC A47J 31/10; A47J 31/46

(57) ABSTRACT

A pour over coffee maker includes a machine body, a water cup and a clamping device, wherein the water cup is arranged on the machine body, and the clamping device is equidistantly arranged on a periphery of a bottom of the machine body. When using the pour over coffee maker, the clamping device is used to clamp a periphery of a coffee cup, and then the hot water is injected into the water cup, so that the hot water flows into a water injection pipe of the machine body through the water cup to enable a spiral water injection device connected to the water injection pipe to performs a spiral water injection operation, and after the hot water is injected for a period of time, the water injection pipe is pressed by an abutting element provided in the machine body to stop the water injection, thereby achieving the function of blooming, and since the size of the pour over coffee maker is only similar in size to that of a filter cup, so it can be carried around and has the function of brewing coffee at any time.

### BACKGROUND OF THE INVENTION

### Field of the Invention

The invention relates to a coffee maker, and more particular, to a pour over coffee maker which can make a pour over coffee and can be carried around.

### Description of the Prior Art

In general, a pour over coffee is made by holding a hand pot to pour the hot water in the hand pot into the filter cup which contains moderately ground coffee powder, wherein the hot water is injected into the filter cup by moving it from the center to the outer edge in a spiral manner, and then moving back in the same manner to the center of the filter cup to soak the coffee. After a required amount of water is reached, it takes a while to wait for the coffee powder to bloom with the hot water. When the coffee powder is blooming, since the hot water comes into contact with the coffee powder, it will accelerate the carbon dioxide emission of the coffee powder to discharge the sour taste of the coffee (because the carbon dioxide creates a sour taste and will make the coffee sour if the coffee is not bloomed properly) and to prevent carbon dioxide from blocking the contact between the hot water and the coffee powder, thereby dissolving the aromatic substances and grease of the coffee. The spiral water injection movement is repeated to brew the delicious pour over coffee.

Since the pour over coffee can provide the original flavor and taste of the coffee compared with the coffee made by the traditional coffee machine, how to make the nozzle of the coffee machine to generate spiral water injection to simulate the pour over method has become an important research topic in designing the coffee machine.

For example, the Taiwan patent No.I536943 titled “Spiral water drip filter coffee machine” provides a coffee machine having a spiral water injection structure, but the aforementioned patent does not provide a blooming function, so the brewed coffee taste is a lot different from that of the pour over coffee. Besides, coffee machines such as Oceanrich_CR8350BD and HARIO V60 on the market have the blooming function, but they do not provide the spiral water injection mode, so the coffee brewed by these models tastes differently from the pour over coffee. Furthermore, the OTFES automatic coffee machine has the functions of blooming and spiral water injection. However, when the coffee machine is used, the coffee powder is poured into the machine, after the brewing, there is a problem of cleaning the coffee machine, and like the coffee machine of Taiwan patent No.I536943 and the Oceanrich_CR8350BD and HARIO V60, it is too big to be carried around and can only be stored in a fixed position. Therefore, for coffee lovers, they don't have the luxury of brewing coffee at any time.

As mentioned above, the current coffee machines still have quite a few problems to overcome. Therefore, in view of the above problems, after years of painstaking research, the inventor of the present invention has improved and innovated the prior art and finally succeeded in researching and developing the pour over coffee maker of the present invention.

### SUMMARY OF THE INVENTION

In order to solve the problems of the prior art technique, it is an object of the present invention to provide a pour over coffee maker which can make a pour over coffee and can be carried around.

In order to solve the problems of the prior art technique, it is an object of the present invention to provide a pour over coffee maker which provides a coffee blooming function.

In order to achieve the above object, the present invention provides a pour over coffee maker, which mainly comprises a machine body, a cup, a top cover, a clamping mechanism, and a control circuit, the cup is disposed above the machine body, the top cover is provided for covering the cup, the clamping mechanism is disposed at the bottom of the machine body, and the control circuit is provided in the machine body, wherein the machine body includes a casing, a positioning socket and a spiral water injection device, the spiral water injection device is pivotally disposed in the positioning socket, and the casing is wrapped around the outer edge of the positioning socket.

At least one water outlet is provided at the bottom of the cup. The casing is disposed with a water injection hole at the top surface thereof, and the water injection hole extends to the bottom of the top surface of the casing to provide a water outlet joint.

The spiral water injection device includes a motor, a helical gear, a planetary bevel gear base, a connecting rod, a water injection positioning joint, and a water injection pipe, the motor is electrically connected to the control circuit; the shaft of the helical gear is connected to the motor; the teeth of the planetary bevel gear base are engaged with the teeth of the helical gear, the planetary bevel gear base has a long hole disposed on one side of the axial center, and the planetary bevel gear base is disposed with an internal gear base on the other side opposite to the long hole, the bottom of the internal gear base is provided with a driven wheel pivotally mounted on the planetary bevel gear base, a planetary gear engaged with an internal gear on the internal gear base is pivotally disposed on one side of the axial center of the driven wheel; the water injection positioning joint includes a connecting pipe and a water discharging unit, wherein the water discharging unit is located at a bottom of the planetary bevel gear seat, and the connecting pipe is disposed in the long hole and pivotally connected with the water discharging unit; the connecting rod has one end pivotally connected to the planetary gear and the other end opposite to the planetary gear pivotally connected to the connecting pipe; and the water injection pipe has one end sleeved on the water outlet joint and the other end extending from the outer side of the planetary bevel gear base to go below the planetary bevel gear base to be connected to the water discharging unit.

The clamping mechanism is electrically connected to the control circuit, wherein the clamping mechanism comprises a plurality of clamping jaws, one end of the clamping jaws is equidistantly disposed at the periphery of the bottom of the machine body, at least one buckle portion is disposed at the bottom of the free end of the clamping jaws.

The machine body further includes a power supply device, the power supply device is an external power cable or a battery built in the machine body,

Furthermore, the casing is disposed with an operating portion electrically connected to the control circuit, wherein the operating portion is used for driving the control circuit to control the motor to start or stop, the operating portion comprises at least one pressing control button, at least one control knob or at least one touch panel.

In addition, the spiral water injection device further includes an abutting element, the abutting element is disposed adjacent to the water injection positioning joint and is electrically connected to the control circuit, the free end of the abutting element is located between the water injection pipe and the water injection positioning joint.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 illustrates a 3D schematic view of a pour over coffee maker of the present invention;

FIG. 2 illustrates an explosive view of the pour over coffee maker of the present invention;

FIG. 3 illustrates a 3D view of the cup of the present invention from another angle;

FIG. 4 illustrates a perspective view of most of the machine body of the pour over coffee maker of the present invention;

FIG. 5 illustrates a further explosive view of FIG. 4;

FIG. 6 illustrates a 3D view of the upper base of the present invention from another angle;

FIG. 7 illustrates a 3D view of the spiral water injection device of the present invention;

FIG. 8 illustrates an explosive view of the spiral water injection device of the present invention;

FIG. 9 illustrates a schematic view of the planetary gear from another angle;

FIG. 10 illustrates a schematic view of the clamping jaw from another angle;

FIG. 11 illustrates a schematic view showing the use state of the pour over coffee maker of the present invention; and

FIG. 12 illustrates a 3D view of the pour over coffee maker of the present invention from another angle.

### DETAILED DESCRIPTION OF THE INVENTION

The invention will be described with reference to the accompanying drawings, and the embodiments of the present invention are described in detail below, and the drawings used in the context are used to describe the features, the contents and the advantages of the invention. The drawings of the present invention are intended to be illustrative only and to assist the description in the specification, and are not intended to limit the scope of the invention in practice.

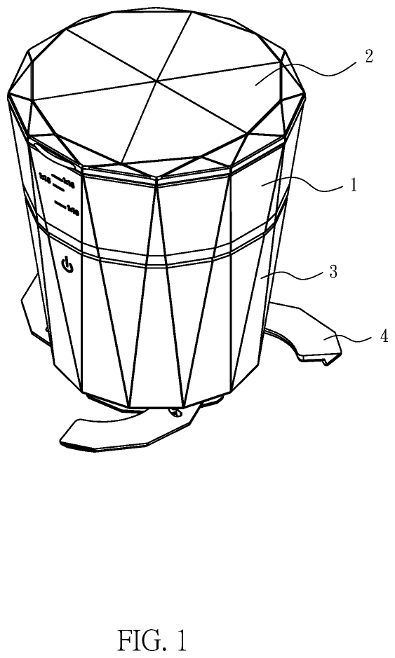

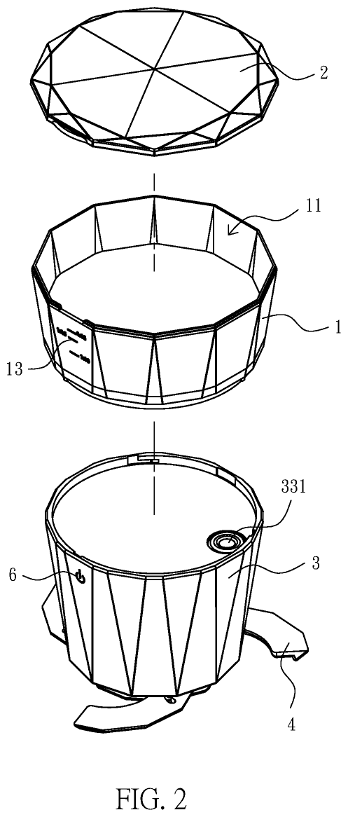

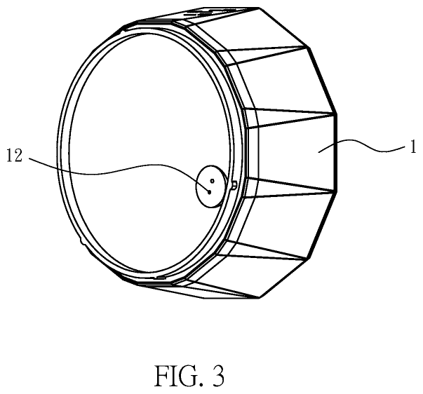

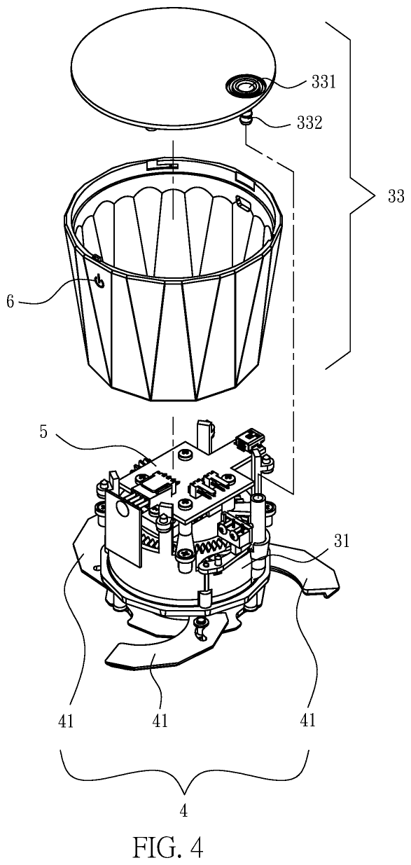

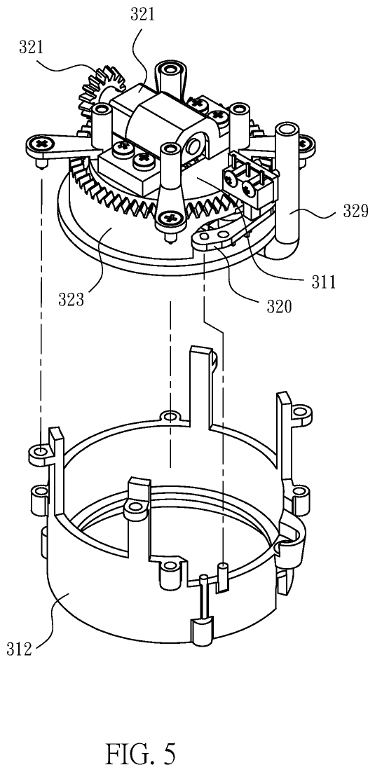

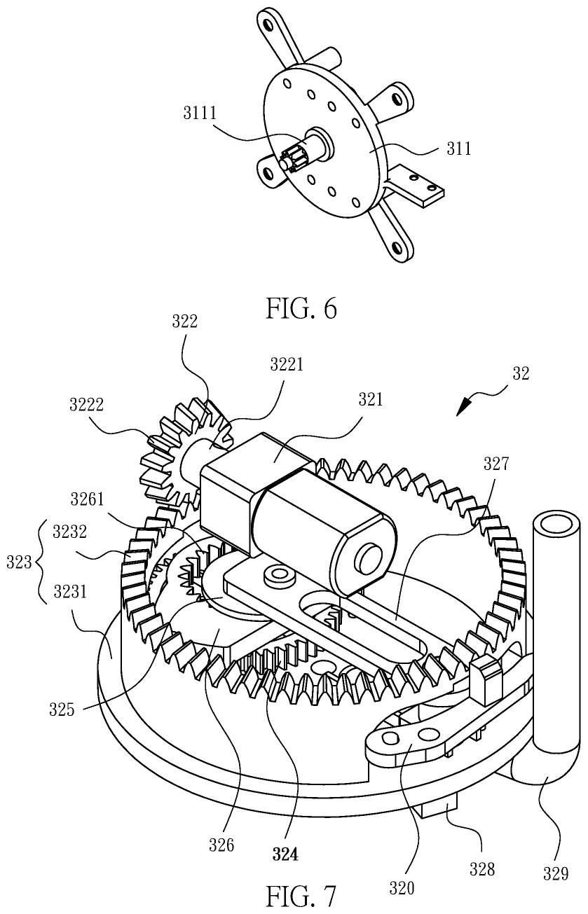

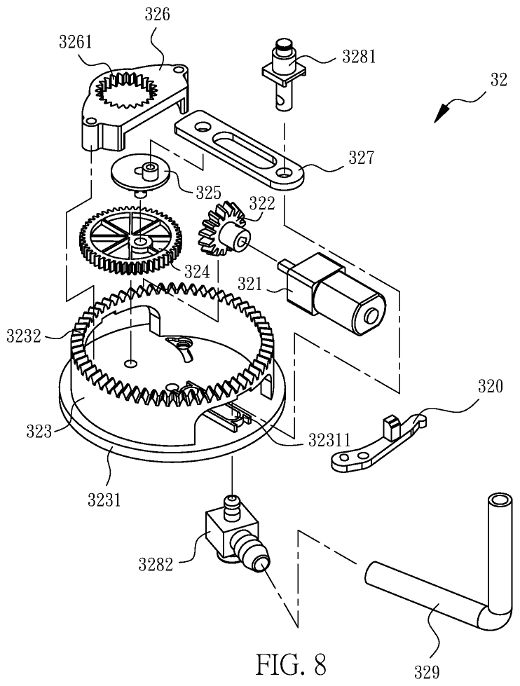

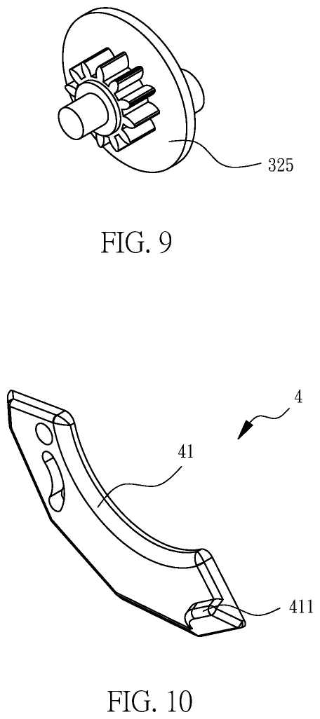

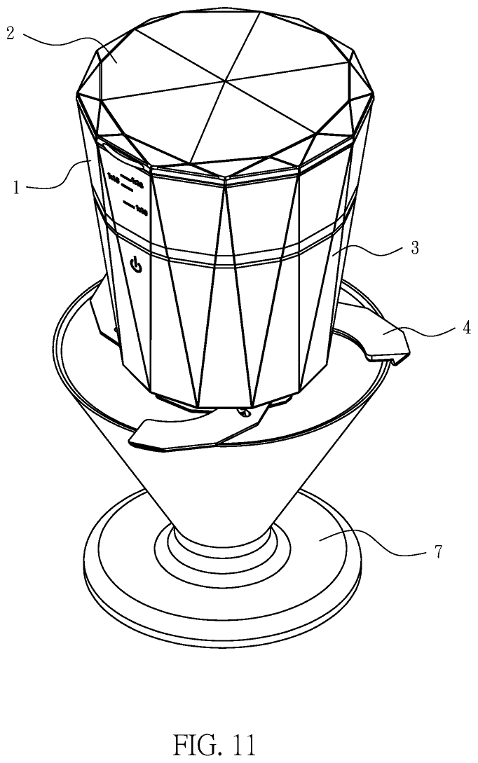

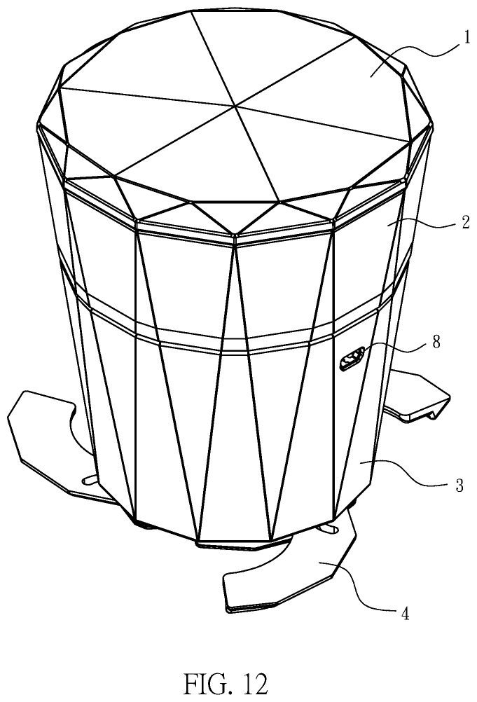

Referring to FIGS. 1 to 12, the present invention provides a pour over coffee maker, which mainly comprises a cup 1, a top cover 2, a machine body 3, a clamping mechanism 4, a control circuit 5, an operating portion 6, and a power supply device (not shown), the cup 1 is a cup structure having a top opening 11, and the bottom of the cup 1 is disposed with at least one water outlet 12, and the surface of the outer edge of the cup is disposed with a water volume ratio scale 13 indicating the ratio of the coffee powder to the water when brewing multiple cups of coffee, and the top cover 2 is used for covering the opening 11 of the cup 1 to prevent dust from flowing into the cup 1 to stain the cup 1 when the pour over coffee maker of the present invention is not in use.

The control circuit 5 is disposed in the machine body 3. The clamping mechanism 4 is electrically connected to the control circuit 5, and the clamping mechanism 4 includes a plurality of clamping jaws 41. One end of the claw 41 is equidistantly disposed on the periphery at the bottom of the machine body 3, and at least one fastening portion 411 is disposed at the bottom of the free end of the clamping jaws 41 opposite to the end pivotally connected to the machine body 3.

The machine body 3 is disposed under the cup, and the machine body 3 includes a positioning socket 31, a spiral water injection device 32 and a casing 33. The positioning socket 31 includes an upper base 311 and a lower base 312; the upper base 311 is locked to the top of the lower base 312. A shaft 3111 extends downwardly from the bottom of the axial center of the upper base 311. The spiral water injection device 32 is pivotally disposed in the lower base 312. The housing 33 is wrapped around the outer edge of the positioning socket 31. The housing 33 has a water injection hole 331 at a position corresponding to the water outlet 12 of the cup 1. The water injection hole 331 extends to the bottom of the top surface of the casing 33 to provide a water outlet joint 332. The operation portion 6 is disposed on the casing 33 of the machine body 3, and the operation portion 6 is electrically connected to the control circuit 5.

The spiral water injection device 32 includes a motor 321, a helical gear 322, a planetary bevel gear base 323, a driven wheel 324, a planetary gear 325, an internal gear base 326, a connecting rod 327, a water injection positioning joint. a positioning joint 328, a water injection pipe 329, and an abutting element 320. The motor 321 is electrically connected to the control circuit 5, and the shaft 3221 of the helical gear 322 is connected to the motor 321. The planetary bevel gear base 323 includes a base 3231 and a ring-shaped planetary bevel gear 3232. The base 3231 is disposed with a long hole 32311 at one end of the axial center thereof, and the planetary bevel gear 3232 is engaged with the teeth 3222 of the helical gear 322. The driven wheel 324 is pivotally disposed on the other side of the base 3231 opposite the long hole 32311, and the driven wheel 324 is engaged with the shaft 3111 of the upper base 311. The planetary gear 325 is pivoted on one side of the axial center of the driven wheel 324; besides, the internal gear base 326 is disposed above the driven wheel 324, and the internal gear 3261 of the internal gear base 326 is engaged with the planetary gear 325. The water injection positioning joint 328 includes a connecting pipe 3281 and a water discharging unit 3282. The water discharging unit 3282 is located under the base 3231. The connecting pipe 3281 is disposed through the long hole 32311 and is pivotally connected to the water discharging unit 3282. One end of the connecting rod 327 is pivotally connected to the connecting pipe 3281, the other end of the connecting rod 327 is pivotally connected to the planetary gear 325. One end of the water injection pipe 329 is sleeved on the water outlet joint 332, the other end of the water injection pipe 329 is pivotally connected to the water discharging unit 3282. One end of the abutting element 320 is pivotally disposed on a side of the lower base 312 of the positioning socket 31, the other end of the abutting element 320 is a free end disposed between the water injection pipe 329 and the connecting pipe 3281 of the water injection positioning joint 328, and the abutting element 320 is electrically connected to the control circuit 5.

When using the pour over coffee maker of the present invention, the user must lay a filter paper (not shown) on the filter cup 7, and then pour the grounded coffee powder on the filter paper. Then, the pour over coffee maker provided by the present invention is placed on the filter cup 7, so that the bottom of the clamping jaw 41 of the clamping structure 4 abuts against the cup edge of the filter cup 7, and then the pour over coffee is activated. The clamping claw 41 of the clamping structure 4 is pivoted with respect to a position pivotally connected to the machine body 3, and the buckle portion 411 disposed at the bottom of the clamping jaw 41 is buckled at the outer edge of the filter cup 7 for fixing the pour over coffee maker of the present invention at a position above the filter cup 7. Meanwhile, the control circuit 5 drives the abutting element 320 to pivot with respect to the position of the lower base 312, and to force the free end of the abutting element 320 to be pressed against the water injection pipe 329.

Then, the top cover 2 is opened and hot water is poured from the opening 11 into the cup 1, and the hot water is poured to the position of the required water amount scale 13 according to the coffee concentration to be brewed, and then the operation portion 6 is used for choosing a brewing mode. In the present embodiment, the operating portion 6 of the pour over coffee maker is a pressing control button, so that the user can press the operating portion 6 several times to adjust the operation mode of the pour over coffee maker to be the continuous water injection mode or the intermittent water injection mode.

Then, the pour over coffee maker of the present invention uses the control circuit 5 to drive the abutting element 320 to pivot with respect to the position of the lower base 312, and to force the free end of the abutting element 320 to stop pressing against the water injection pipe, so that the hot water in the cup 1 flows from the water outlet 12 through the water injection hole 331, the water outlet joint 332 and the water injection pipe 329 to the water outlet positioning joint 328, and the control circuit 5 is used for simultaneously starts the motor 321 to drive the helical gear 322, and to further drive the planetary bevel gear base 323 to rotate in the positioning socket 31 by the teeth 3222 of the helical gear 322. At this time, the driven wheel 324 disposed on the base 3231 of the planetary bevel gear base 323 revolves with respect to the planetary bevel gear base 323 and is driven by the shaft 3111 to rotate by itself, and at the same time, the planetary gear 325 pivotally disposed on one side of the shaft is driven to revolve with respect to the internal gear 3261 of the internal gear base 326. At this time, one end of the connecting rod 327 pivotally disposed on the planetary gear 325 is driven by the planetary gear 325 to revolve with the planetary gear 325, and when the planetary gear 325 revolves around the inner gear 3261 to drive the connecting rod 327 to move towards the long hole 32311 at the farther end of the base 3231, the connecting pipe 3281 pivotally disposed at the other end of the connecting rod 327 is driven to move in the direction of the inner gear base 326 in the long hole 32311. At this time, the water discharging unit 3282 disposed under the base 3231 and pivotally connected to the connecting tube 3281 rotates with the planetary gear base 323 and gradually moves towards the axial center of the planetary gear carrier 323, thereby forming a spiral path revolving around the axial center of the planetary gear base 323. At this time, the hot water flowing into the water injection pipe 329 through the cup 1 follows the spiral path of the water discharging unit 3282 to be injected into the filter cup.

Thereafter, the control circuit 5 drives the abutting element 320 to pivot with respect to the position pivotally connected to the lower base 312, to force the free end of the abutting element 320 to press the water injection pipe 329 to stop the water injection. At the same time, the control circuit 5 also stops the operation of the motor 321, so that the water discharging unit 3282 stops the spiral water injection operation to enable blooming, which helps discharge the sour taste of the coffee and dissolves the aromatic substances and grease of the coffee. Afterwards, the control circuit 5 re-activates the motor 321, and stops the free end of the abutting element 320 from pressing the water injection pipe 329, and repeats the process mentioned above to restart the water injection for the brewing operation of the coffee.

In addition, when one end of the connecting rod 327 pivotally connected to the planetary gear 325 is driven by the planetary gear 325 to move towards the long hole 32311 on the other end of the base 3231, the connecting pipe 3281 pivotally connected to the other end of the connecting rod 327 is driven by the connecting rod 327 to move in the long hole 32311 and away from the inner gear base 326. At this time, the water discharging unit 3282 which is originally spirally revolving toward the axial center of the planetary bevel gear base 323 starts to form a spiral path to move towards the outer edge of the planetary bevel gear base 323; therefore, when the planetary gear 325 has revolved around the inner gear 3261 for one circle, the water discharging unit 3282 will move along a path that is spirally wound from the outer edge of the bottom of the planetary bevel gear base 323 towards the axial center and then circled outwards, thereby achieving the purpose of the spiral water injection; and since the water discharging unit 3282 is pivotally connected to the connecting pipe 3281, when the water discharging unit 3282 is spirally revolving, the water discharging unit 3282 is also rotating with respect to the position pivotally connected to the connecting pipe 3281, thereby preventing the water injection pipe 329 connected to the water discharging unit 3282 from being knotted or torn off as the water discharging unit 3282 is spirally revolving.

In addition, the pour over coffee maker of the present invention can also control the water injection without using the abutting element 320 to press the water injection pipe 329, but by disposing an electric valve (not shown) on one of the water outlet 12, the water injection hole 331, the water outlet joint 332, the water injection pipe 329, or the water discharging unit 3282 and using the control circuit 5 to turn on or off the electric valve to perform water injection control, thereby controlling the time of blooming

Referring to FIG. 12, the pour over coffee maker of the present invention further includes a power supply device 8. In the embodiment, the power supply device 8 is a charging connector for plugging the power cable. The power supply device 8 can provide the power required by the motor 321 and the control circuit 5, and the power supply device 8 can also be a replaceable general battery or a rechargeable battery.

Furthermore, the pour over coffee maker of the present invention further comprises a micro switch, a timer, and an LED light, etc., in addition to the aforementioned mechanism, to detect the water injection stroke of the spiral water injection device 32 by the micro switch, to calculate the spiral water injection and the blooming time by using the timer, and to indicate the operation state by the LED light; however, the water injection stroke, water injection, blooming time, and the LED light display are only one embodiment of the present invention, and all the above mentioned elements can be controlled by the control circuit 5 and are not intended to limit the scope of the present invention.

In addition, in the pour over coffee maker of the present invention, the operation portion 6 can have a control knob mode or a touch panel operation mode in addition to the control pressing mode, so that the user can rotate the control knob to turn on the pour over coffee maker, and to rotate the segment to set the continuous water injection or intermittent water injection mode, or use the touch panel to activate the pour over coffee maker and to select the continuous water injection or intermittent water injection mode, etc. to control the pour over coffee maker of the present invention.

As described above, the pour over coffee maker of the present invention can be directly placed on the filter cup, has a smaller size than the conventional pour over coffee maker, and can be carried around to provide the function of brewing coffee at any time; and the pour over coffee maker of the present invention has the blooming function, so that the brewed coffee has the same flavor as the pour over coffee. Besides, the pour over coffee maker of the present invention does not require the user to pour the coffee powder into the machine body or the cup of the machine body, and there is no need to clean the coffee machine.

The present invention has been described with preferred embodiment of the present invention; however, this embodiment is not intended to limit the scope of the patent of the present invention. Many changes and modifications in the above described embodiment of the invention can, of course, be carried out without departing from the scope thereof.

What is claimed is:

1. A pour over coffee maker disposed directly on a filter cup for spiral water injection, comprising:
a cup having an open cup structure for receiving hot water, the bottom of the cup having at least one water outlet;
a machine body, wherein the machine body is disposed under the cup, the machine body is provided with a spiral water injection device and a water injection pipe, and the water injection pipe is used for connecting the water outlet and a water injection positioning joints at the bottom of the spiral water injection device, so as to guide the hot water in the cup to the water injection positioning joint;
a control circuit electrically connected to the spiral water injection device for driving the water injection positioning joint to rotate under the spiral water injection device; and
an abutting element electrically connected to the control circuit to press the water injection pipe to intercept the hot water in the water injection pipe from flowing into the water injection positioning joint.

2. The pour over coffee maker as claimed in claim 1, wherein the machine body includes a positioning socket, a casing and the spiral water injection device, the spiral water injection device is pivotally disposed in the positioning socket, the casing is wrapped around the outer edge of the positioning socket, and the casing is disposed with a water injection hole at the top surface thereof, and the water injection hole extends to the bottom of the top surface of the casing to provide a water outlet joint.

3. The pour over coffee maker as claimed in claim 2, wherein the spiral water injection device includes:
a motor electrically connected to the control circuit;
a helical gear, wherein a shaft of the helical gear is connected to the motor;
a planetary bevel gear base, wherein the teeth of the planetary bevel gear base are engaged with the teeth of the helical gear, the planetary bevel gear base has a long hole disposed on one side of the axial center, and the planetary bevel gear base is disposed with an internal gear base on the other side opposite to the long hole, the bottom of the internal gear base is provided with a driven wheel pivotally mounted on the planetary bevel gear base, a planetary gear engaged with an internal gear on the internal gear base is pivotally disposed on one side of the axial center of the driven wheel;
the water injection positioning joint including a connecting pipe and a water discharging unit, wherein the water discharging unit is located at a bottom of the planetary bevel gear seat, and the connecting pipe is disposed in the long hole and pivotally connected with the water discharging unit;
a connecting rod having one end pivotally connected to the planetary gear, and the connecting rod having the other end opposite to the planetary gear pivotally connected to the connecting pipe; and
the water injection pipe having one end sleeved on the water outlet joint and the other end extending from the outer side of the planetary bevel gear base to go below the planetary bevel gear base to be connected to the water discharging unit.

4. The pour over coffee maker as claimed in claim 3, wherein the casing is disposed with an operating portion electrically connected to the control circuit.

5. The pour over coffee maker as claimed in claim 4, wherein the operating portion comprises at least one pressing control button, at least one control knob or at least one touch panel.

6. The pour over coffee maker as claimed in claim 3, wherein one end of the abutting element is pivoted on a side of the positioning socket, and the other end of the abutting element is a free end locating between the water injection pipe and the water injection positioning joint.

7. The pour over coffee maker as claimed in claim 1 further comprising a top cover for covering the opening of the cup.

8. The pour over coffee maker as claimed in claim 1 further comprising a clamping mechanism electrically connected to the control circuit, wherein the clamping mechanism comprises a plurality of clamping jaws, one end of the clamping jaws is equidistantly disposed at the periphery of the bottom of the machine body, at least one buckle portion is disposed at the bottom of the free end of the clamping jaws.

9. The pour over coffee maker as claimed in claim 1, wherein the machine body further includes a power supply device, the power supply device is an external power cable or a battery built in the machine body.

10. The pour over coffee maker as claimed in claim 9, wherein the battery is a general battery or a rechargeable battery.
